(19) United States
(12) Patent Application Publication
(10) Pub. No.: US 2025/0279667 A1
(43) Pub. Date: Sep. 4, 2025

(54) BATTERY CHARGING SYSTEM, BATTERY POWER SYSTEM, AND METHOD OF USING QUICK CHARGER TO CHARGE BATTERY OF ELECTRICALLY POWERED TOOL

(71) Applicant: Honda Motor Co., Ltd., Tokyo (JP)

(72) Inventors: Kyusang RO, Novi, MI (US); Brian DOKLOVIC, Chapel Hill, NC (US)

(21) Appl. No.: 18/591,603

(22) Filed: Feb. 29, 2024

(51) Int. Cl. H02J 7/00

(52) U.S. Cl. CPC H02J 7/007194; H02J 7/0045

(57) ABSTRACT

A battery charging system can include each of a heating element, a heating fan, and a cooling fan located in an airflow path, and a controller configured to operate the heating mode when a battery is connected to the battery charging system and a sensed temperature of the battery is less than a predetermined low threshold. The controller can be configured to operate the heating mode by disconnecting a charging power from the battery, supplying a fan power to the heating fan to force air to flow along the airflow path, supplying a heat power to the heating element to emit heat into the airflow path, and disconnecting a cooling power from the cooling fan. In the heating mode, air flowing along the airflow path flows through the heating fan and enters the heating element, and subsequently exits the heating element and passes along the cooling fan.

### BACKGROUND

The disclosed subject matter relates to a battery charging system for charging a battery of an electrically powered tool. More particularly, the disclosed subject matter relates to methods and apparatus that heat the battery prior to charging the battery when the battery is cold.

Power equipment such as, but not limited to, a lawnmower, a snowblower, a lawn edger, a tiller, an aerator, a string trimmer, and a hedge trimmer, can include an electric motor that powers the tool and a rechargeable battery that supplies electrical power to the electric motor. The temperature at which the rechargeable battery is charged can adversely impact the lifespan of the battery.

A rechargeable battery for power equipment can include a plurality of cells arrayed or stacked inside a housing. The temperature of each of the cells can increase during the charging process. Conventional battery chargers can include a cooling fan that blows air through the housing and along the cells during the charging process so that the temperature of the cells can be maintained below a predetermined maximum temperature.

### SUMMARY

Some embodiments are directed to a battery charging system that can include a heating element located in an airflow path, a heating fan located in the airflow path, a cooling fan located in the airflow path, and a controller configured to operate a heating mode. The heating fan can be located in the airflow path upstream of the heating element when the heating fan is operated during a heating mode. The cooling fan can be located in the airflow path downstream of the heating element when the heating fan is operated during the heating mode. The controller can be configured to operate the heating mode when a battery is connected to the battery charging system and a sensed temperature of the battery is less than a predetermined low threshold. The controller can be configured to operate the heating mode by disconnecting or maintaining disconnection of a charging power from the battery, supplying or maintaining a fan power to the heating fan to force air to flow along the airflow path, supplying or maintaining a heat power to the heating element to emit heat into the airflow path, and disconnecting or maintaining disconnection of a cooling power from the cooling fan. In the heating mode, air flowing along the airflow path flows through the heating fan and enters the heating element, and the air that enters the heating element exits the heating element and passes along the cooling fan.

Some embodiments are directed to a battery charging system for an apparatus that includes an electric motor and a tool driven by the electric motor. The battery charging system can include a battery and a quick charger. The battery can be configured to be removably mounted on the apparatus and electrically connected to the apparatus to supply electrical power to the motor when the battery is mounted on the apparatus. The quick charger can be connected to a power supply and include a battery dock, a heater, a cooling fan and a controller. The battery dock can be configured to removably receive the battery and electrically connect the battery to the quick charger when the battery is received in the battery dock. The heater can be located on an airflow path that passes along the battery dock and configured to heat the battery when the battery is received in the battery dock. The cooling fan can be located on an airflow path between the battery dock and the heater. The controller can be configured to operate a heating mode when the battery is received in the battery dock and a sensed temperature is less than a predetermined low threshold. The controller can be configured to operate the heating mode by disconnecting or maintaining disconnection of a charging power from the battery, connecting or maintaining connection of a heat power to the heater, and disconnecting or maintaining disconnection of a cooling power from the cooling fan.

Some embodiments are directed to a method of using a quick charger to charge a battery mounted in the quick charger. The quick charger can have a heater, a cooling fan, and an opening adjacent to the battery when the battery is mounted in the quick charger. The method can include: locating the heater, the cooling fan and the opening in an airflow path that extends from the heater and through the opening such that the cooling fan is located between the heater and the opening; and when a sensed temperature of the battery is less than a predetermined low threshold, disconnecting or maintaining disconnection of the battery from a power supply; connecting or maintaining connection of the heater to one of the power supply and the battery, and disconnecting or maintaining disconnection of the cooling fan from the power supply.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a battery connected to a battery dock of a battery charging system made in accordance with principles of the disclosed subject matter.

FIG. 2 is a perspective view of the battery charging system of FIG. 1, with the battery removed from the battery dock of the battery charging system.

FIG. 3 is a rear perspective view of a snowblower using a battery that can be charged with the battery charging system of FIG. 1.

FIG. 4 is a schematic illustration of the battery charging system of FIG. 1 with the battery removed from the battery dock.

FIG. 5 is a schematic illustration of the battery and the battery charging system of FIG. 1, with the battery charging system operating in a heating mode.

FIG. 6 is a schematic illustration of the battery and the battery charging system of FIG. 1, with the battery charging system operating in a cooling mode.

FIG. 7 is a flowchart depicting an operation of the battery charging system of FIG. 1.

FIG. 8 is a perspective cross-sectional view of the battery shown in the battery charging system of FIG. 1.

FIG. 9 is a schematic illustration of an alternate embodiment of a battery charger system made in accordance with principles of the disclosed subject matter.

FIG. 10 is an end view of the battery in the battery charging system of FIG. 1.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

Some battery charging systems can take many hours or most of a day to charge the battery. Quick battery charging systems can charge the battery to 80% capacity in one hour or less, and charge the battery to 100% capacity in less than five hours.

Charging a battery with a quick charger at a temperature that is lower than a predetermined minimum temperature can adversely affect the lifespan and/or performance of the battery. Thus, battery's manufacturer sometimes recommends a temperature range for quick charging a battery. The temperature range can be greater than or equal to a predetermined minimum temperature and less than or equal to a predetermined maximum temperature.

Typically, an owner of power equipment stores the power equipment in an indoor environment that is not heated. Some power equipment such as, but not limited to, snowblowers can be operated and/or stored in an environment with an ambient temperature that is below the predetermined minimum temperature. Thus, it is possible for an owner or potential customer to perceive power equipment that is operated by an electric battery to be incompatible with their needs if it becomes difficult to charge the battery at low temperatures.

Further, the owner or potential customer may adversely perceive the benefit of a quick charger when the battery is stored or used in an environment with an ambient temperature that is below the predetermined minimum temperature. Although the battery could be stored or brought into a heated environment, the owner of the power equipment can perceive the storage of the battery in the heated environment as inconvenient. Alternatively, the owner or user could bring the battery that has been stored in a relatively cold environment into a relative warm environment to warm the battery. The time to raise the battery temperature above the minimum threshold can be longer than the charging time when using a quick charger. Thus, the owner or user of the quick charger can negatively perceive the benefit of the quick charger.

Accordingly, there is a need for a battery charging system that can relatively quickly charge a battery that is initially at a temperature that is below the predetermined minimum temperature.

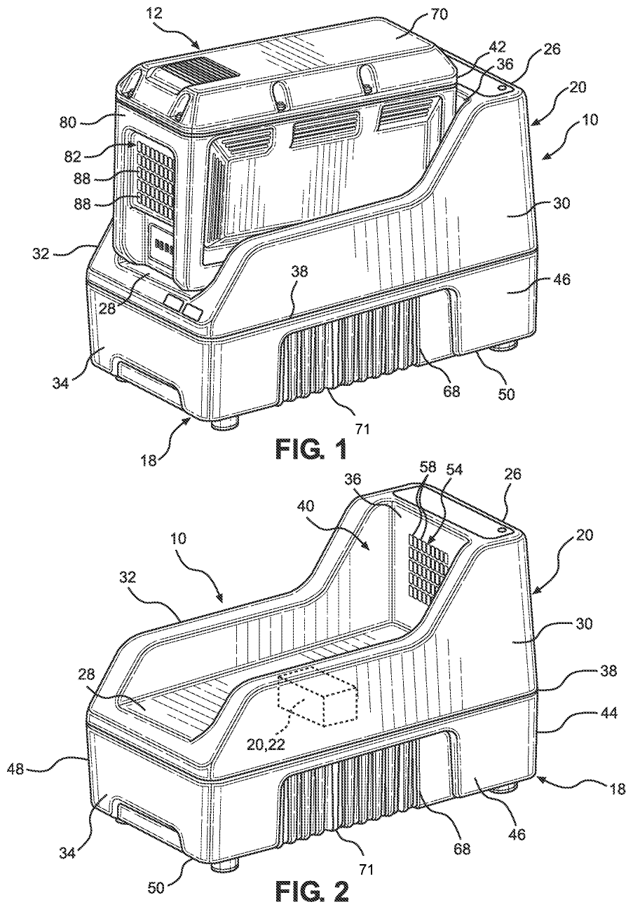

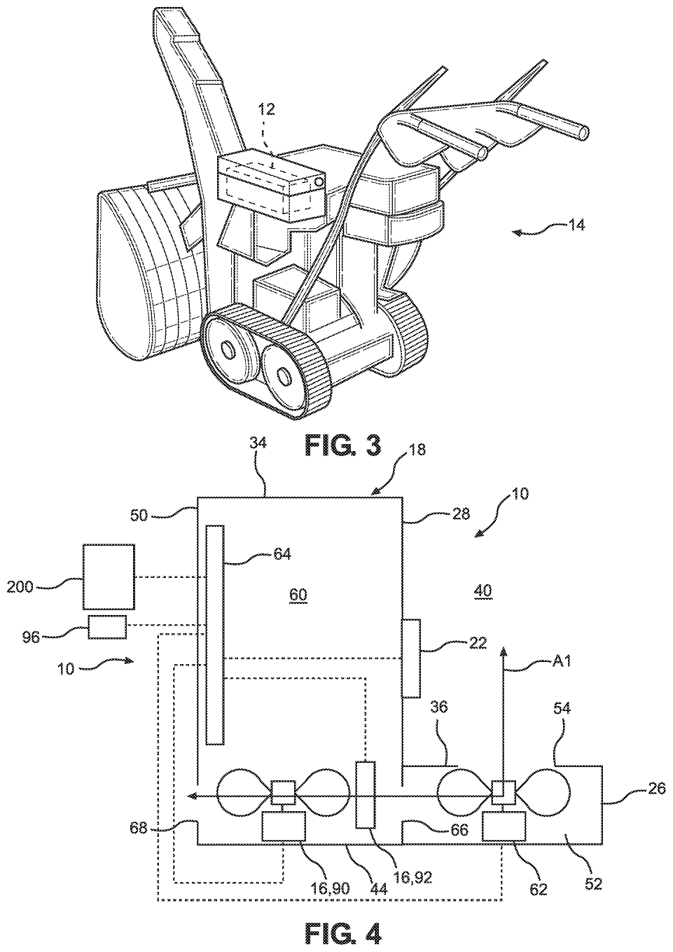

FIG. 1 illustrates an embodiment of a battery charging system 10 made in accordance with principles of the disclosed subject matter. The battery charging system 10 can use a process that allows the battery charging system 10 to perform a quick charge cycle. In certain cases, the battery charging system 10 can use a process that performs a charge cycle that is longer in time than a quick charge cycle. The battery charging system 10 can charge a battery 12 for use in electrically powered equipment 14 (see FIG. 3) such as but not limited to a lawnmower, a snowblower, a lawn edger, a tiller, an aerator, a string trimmer, and a hedge trimmer. The electrically powered equipment can be referred to as power equipment, a power tool, a powered tool, an electric tool, a power machine, a powered machine, or an electric machine. The battery charging system 10 and the battery 12 can be collectively referred to as a battery power system.

FIG. 2 shows the battery charging system 10 with the battery 12 removed. FIG. 3 shows an exemplary electrically powered equipment 14 configured as a snowblower that can use the battery 12 that has been charged by the battery charging system 10. The battery 12 can be removed from the snowblower 14 and charged in the battery charging system 10 and then returned to the snowblower 14 or used in a different type of electrically powered equipment that is compatible with the battery 12.

FIG. 4 schematically illustrates the battery charging system 10 of FIG. 1. The battery charging system 10 can include a heater 16 that heats the battery 12 when the battery 12 is less than a predetermined low temperature threshold. The battery charging system 10 can be configured to automatically start charging the battery 12 when the temperature of the battery 12 is greater than or equal to the low temperature threshold. The predetermined low temperature threshold can be greater than or equal to the predetermined minimum temperature that is set by the manufacturer of the battery 12. The heater 16 can be configured to transfer heat to the battery 12 at a rate that is sufficient for the owner or user of the battery charging system 10 to positively perceive the time that has elapsed to heat and charge the battery 12.

Returning to FIGS. 1 and 2, the battery charging system 10 can include a housing 18 and a battery dock 20 that is connected to the housing 18 in any appropriate manner such as, but not limited to, threaded fasteners, elastic clips, clamps, staking, welding, adhesive. A seam 38 can delineate the housing 18 from the battery dock 20. The seam 38 can extend around the entire perimeter of the housing 18 and the battery dock 20.

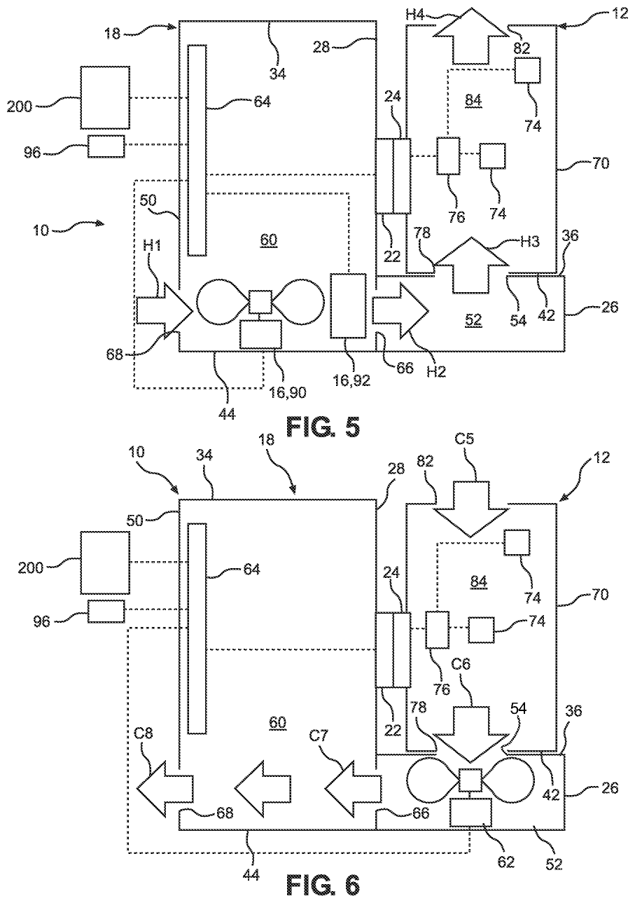

Referring to FIG. 2, the battery dock 20 can include a connector 22, an end wall 26, a support wall 28, and a pair of side walls 30, 32. The connector 22 is obstructed from view in FIG. 1 by the first side wall 30 and the battery 12 and obstructed from view in FIG. 2 by the first side wall 30. The connector 22 is schematically illustrated in phantom in FIG. 2 and schematically illustrated in FIG. 4. Referring to FIGS. 5, 6, and 10, the battery 12 can include a mating connector 24 that can be connected to the connector 22 to electrically connect the battery 12 to the battery charging system 10. The mating connector 24 of the battery 12 is obstructed from view in FIG. 1 by the first side wall 30 and the battery 12. The mating connector 24 is schematically illustrated in FIGS. 5, 6, and 10.

Returning to FIG. 2, the connector 22 can protrude from the support wall 28. Each of the connectors 22, 24 can include one or more terminals for transmitting charging power and one or more terminals for transmitting electrical control signals between the battery 12 and battery charging system 10. Each of the power terminal(s) of the connector 22 can be connected to a respective one of the power terminal(s) of the mating connector 24 and each of the signal terminal(s) of the connector 22 can be connected to a respective one of the signal terminal(s) of the mating connector 24.

The walls 26, 30, 32 can extend away from the support wall 28. The walls 26, 28, 30, 32 can extend along and form a boundary of an external space 40 of the battery dock 20. That is, the external space 40 can extend along the outer surfaces of the battery dock 20 that are located on the walls 26, 28, 30, 32. The battery 12 can be located in the external space 40 when the battery 12 is mounted on or in the battery dock 20 with the connectors 22, 24 connected to each other.

The first end wall 26 can include an end surface 36 that faces the battery 12 and is adjacent to the battery 12 when the battery 12 is mounted in the battery dock 20. Referring to FIGS. 1 and 10, the battery 12 can include a first end surface 42 that faces the end surface 36 of the battery dock 20. The surfaces 36, 42 can be spaced away from each other.

Referring to FIG. 4, the first end wall 26 can be a hollow wall that includes an internal space 52. The battery dock 20 can include a dock opening 54 extending through the end surface 36. The dock opening can be in fluid communication with each of the external space 40 and the internal space 52. Referring to FIG. 2, the dock opening 54 can include a plurality of holes 58 extending through the end surface 36.

Referring to FIGS. 1, 2 and 4 collectively, the housing 18 can include a first end wall 44, a second end wall 34, a pair of side walls 46, 48 and a bottom wall 50. Referring to FIG. 4, the housing 18 can include an interior space 60 that is bound by the walls 34, 44, 46, 48, 50. The housing 18 can include an opening that is bound by edges of the walls 34, 44, 46, 48 that are adjacent to the seam 38. Components of the battery charging system 10 can be inserted into the interior space via the opening during assembly of the battery charging system 10. The support wall 28 can extend along the internal space 52 and close the opening. The interior space 60 can be referred to as a compartment.

Referring to FIG. 4, the battery charging system 10 can include a cooling fan 62. The cooling fan 62 can be located in the internal space 52 of the end wall 26. The cooling fan 62 can be any appropriate fan such as, but not limited to, an axial-flow fan or a centrifugal fan. The internal space 52 can be referred to as a compartment.

The battery dock 20 can include an intermediate opening 66 that extends through the support wall 28. The intermediate opening 66 can be in fluid communication with both of the internal space 52 of the battery dock 20 and the interior space 60 of the housing 18.

Returning to FIGS. 1, 2 and 4, the housing 18 can include housing opening 68 that is in fluid communication with the interior space 60 of the housing 18 and an ambient environment that is outside of the housing 18 and the battery dock 20. The housing opening 68 can extend through the first side wall 30 as shown in FIGS. 1 and 2. In alternate embodiments, the housing opening 68 can extend through the bottom wall 50 as schematically illustrated in FIGS. 4-6. Referring to FIGS. 1 and 2, the housing 18 can include a grille 70 that extends across the housing opening 68.

Referring to FIG. 4, each of the openings 54, 66, 68, the cooling fan 62 and the heater 16 can be located on an airflow path A1 that is schematically indicated by a double headed arrow. The heater 16 and the airflow path A1 can be configured to draw air from the ambient environment outside of the housing 18 into the housing 18 via the housing opening 68 and exhaust the heated air through the dock opening 54 and into the external space 40 of the battery dock 20. The cooling fan 62 and the airflow path A1 can be configured to draw air from the external space 40 through the dock opening 54 and into the housing 18 and exhaust the air via the housing opening 68 to the ambient environment.

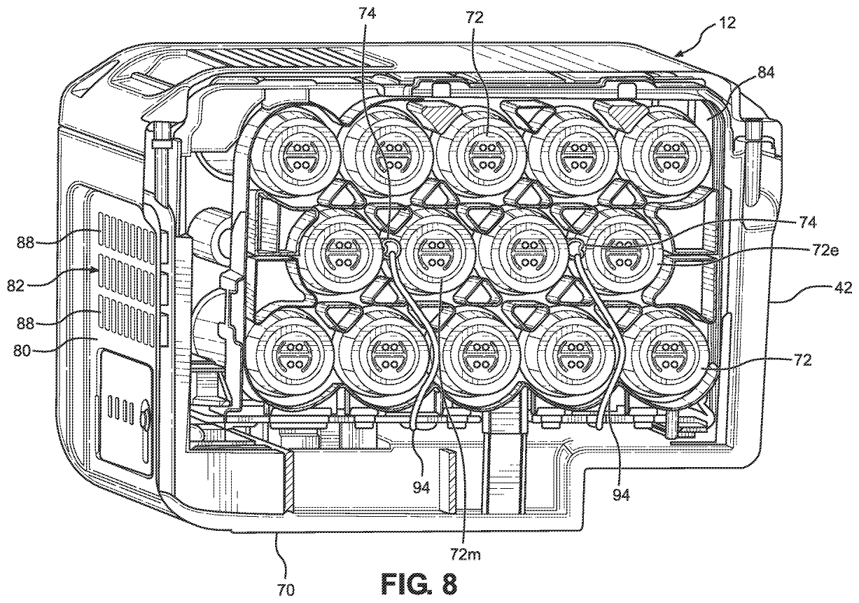

Referring to FIG. 8, the battery 12 can include a battery housing 70, a plurality of battery cells 72 and a plurality of sensors 74. The inside of the housing 70 can be referred to as a battery compartment 84 and the battery cells 72 can be contained in the battery compartment 84. Each of the sensors 74 can be mounted on a respective one of the battery cells 72.

The battery cells 72 can be arranged in any appropriate manner such as, but not limited to, a plurality of staggered rows or staggered columns. The battery cells 72 can include a middle battery cell 72m and an end battery cell 72e. The middle battery cell 72m can be encircled by a subset of the plurality of battery cells 72. FIG. 8 shows a subset of six battery cells 72 encircling the middle battery cell 72m. The end battery cell 72e can be the last battery cell 72 of a given row or given column of the battery cells 72.

Each of the sensors 74 can be any appropriate temperature sensor such as, but not limited to a thermistor. Electrical wires 94 can connect the sensors 72 to the electronic component 76. The sensors 74 can be configured to output data (or a signal) that is indicative of the temperature of the associated one of the battery cells 72e, 72m. The electronic component 76 can be configured to store the temperature data until requested by the controller 64 and transmit the temperature data to the controller 64 when requested by the controller 64.

Referring to FIGS. 1, 8 and 10 collectively, the battery housing 70 can include a first ventilation opening 78, a second end wall 80, a second ventilation opening 82 and a battery compartment 84. The first ventilation opening 78 can extend through the first end surface 42. The first ventilation opening 78 can be located in the external space 40 of the battery dock 20 and oppose the dock opening 54 when the connectors 22, 24 are connected to each other. The second end 80 wall can be spaced away from the first end surface 42 and the second ventilation opening 82 can extend through the second end wall 80. Both of the second end wall 80 and the second ventilation opening 82 can be outside of both of the housing 18 and the battery dock 20. Both of the ventilation openings 78, 82 can be in fluid communication with the battery compartment 84. The first ventilation opening 78 can include a plurality of holes 86 extending through the first end surface 42 and the second ventilation opening 82 can include a plurality of holes 88 extending through the second end wall 80.

The battery charging system 10 can heat the battery 12, charge the battery 12, and cool the battery 12, when the battery 12 is mounted on or in the battery dock 20 and the mating connector 24 is connected to the connector 22. FIG. 5 shows air flowing along the airflow path A1 when the battery charging system 10 is operating in a heating mode that heats the battery 12 prior to charging the battery 12. FIG. 6 shows air flowing along the airflow path A1 when the battery charging system 10 is operating in a cooling mode that cools the battery 12 while charging the battery 12. That is, the battery 12 can remain mounted on or in the battery dock 20 when the battery charging system 10 heats the battery 12, charges the battery 12, and cools the battery 12 during charging. The cooling fan 62 is omitted from FIG. 5 and the heater 16 is omitted from FIG. 6 for clarity and simplicity of the drawings.

Returning to FIG. 4, the heater 16 can include a heating fan 90 and a heating element 92. The heating fan 90 can be any appropriate fan such as, but not limited to, an axial-flow fan or a centrifugal fan. The heating element 92 can be any appropriate heating device such as, but not limited to, an electric resistance heating element, a ceramic heating element, or an infrared heat lamp, or any combination of these exemplary heating devices.

The heating fan 90 and the heating element 92 can be located in the airflow path A1 between the intermediate opening 66 and the housing opening 68. The heating fan 90 can be positioned in the airflow path A1 at a location that is between the heating element 92 and the housing opening 68. The heating element 92 can be positioned in the airflow path A1 at a location that is between the heating fan 90 and the intermediate opening 66. That is, the heating fan 90 can be spaced away from the housing opening 68 by a distance that is less than the distance by which the heating element 92 is spaced from the housing opening 68, and the heating element 92 can be spaced away from the intermediate opening 66 by a distance that is less than the distance by which the heating fan 90 is spaced from the intermediate opening 66, as shown in FIG. 4.

The battery charging system 10 can operate in a heating mode when the temperature of the battery 12 is less than or equal to a predetermined low temperature T_{Low} and in a cooling mode when the temperature of the battery 12 is greater than or equal to a predetermined high temperature T_{High}. The predetermined low temperature T_{LOW} can be greater than or equal the predetermined minimum temperature set by the manufacture of the battery 12. The predetermined high temperature T_{High} can be less than or equal the predetermined maximum temperature set by the manufacture of the battery 12

When the battery charging system 10 and the heater 16 are in a heating mode, air from the ambient environment outside of the housing 18 can be drawn into the housing 18 by the heater 16 and the air heated by the heater 16 can be exhausted into the battery 12 as indicated by arrows H1-H4 in FIG. 5. The heating fan 90 can draw the ambient air that is outside the housing 18 through the housing opening 68 and into the interior space 60 of into the housing 18 as indicated by the first arrow H1. The heating fan 90 can force the air that is drawn in through the housing opening 68 and into the housing's interior space 60 to flow across and/or through the heating element 92. The heating fan 90 can force the air flowing across the heating element 92 to exit the interior space 60 through the intermediate opening 66 and enter the internal space 52 of the end wall 26 of the battery dock 20 as indicated by the second arrow H2. The heating fan 90 can force the air that enters the internal space 52 via the intermediate opening 66 to exit the internal space 52 through the dock opening 54 and enter the battery 12 via the first ventilation opening 78 as indicated by the third arrow H3. The heating fan 90 can force the air that enters the battery 12 to flow through the battery compartment 84 and across or along each of the battery cells 72. The heating fan 90 can force the air flowing across or along the battery cells 12 to exit the battery compartment 84 through the second ventilation opening 82 and flow into the ambient environment as indicated by the fourth arrow H4. Thus, the heater 16 can heat the battery cells 72 when the battery cells 72 are at a temperature that is less than the predetermined low temperature T_{Low}. The battery charging system 10 can be configured to automatically charge the battery 12 after the battery charging system 10 heats the battery to a temperature that is greater than or equal to the predetermined low temperature T_{Low}.

During charging, the temperature of the battery 12 can increase. Quick charging (also referred to as fast charging) the battery 12 when the battery 12 is at a temperature that the is greater than a predetermined maximum temperature can adversely impact the battery 12. Thus, the battery charging system 10 and the cooling fan 62 can operate in the cooling mode to maintain the battery temperature at or below the predetermined high temperature T_{High}.

When the battery charging system 10 and the cooling fan 62 are in a cooling mode, air from the ambient environment outside of both of the battery 12 and the battery charging system 10 can be drawn through the battery 12 by the cooling fan 62 as indicated by arrows C5-C8 in FIG. 6. The cooling fan 62 can draw the ambient air that is outside the battery 12 through the second ventilation opening 82 and into the battery compartment 84 as indicated by the fifth arrow C5. The cooling fan 62 can force the air that is in the battery compartment 84 to flow across or along each of the battery cells 72. The cooling fan 62 can force the air flowing across the battery cells 72 to exit the battery compartment 84 through the first ventilation opening 78 and enter the internal space 52 of the end wall 26 of the battery dock 20 via the dock opening 54 as indicated by the sixth arrow C6. The cooling fan 62 can force air in the internal space 52 to exit the internal space 52 through the intermediate opening 66 and enter the interior space 60 of the housing 18 as indicated by the seventh arrow C7. The cooling fan 62 can force the air to exit the interior space 60 through the housing opening 68 and into the ambient environment. Thus, the cooling fan 62 can cool the battery cells 72 when the battery cells 72 are at a temperature that is greater than the predetermined high temperature T_{High}.

Returning to FIG. 4, the battery charging system 10 can include a controller 64 in electrical communication with each of the heater 16, the connector 22 and the cooling fan 62 as shown schematically by the dotted lines. Each of the dotted lines can schematically represent at least one power supply line and/or at least one electrical communication line. The controller 64 can be referred to as a processor based controller, a microcomputer, an electronic control unit, or an ECU. The controller 64 can be configured with hardware alone, or with a combination of hardware and software that permit the controller 64 to perform the tasks described herein. The controller 64 can include a central processing unit (“CPU”), a RAM, a ROM and/or an interface that connects the controller 64 to any or all of the connector 22, the heater 16 and the cooling fan 62. The controller 64 can be connected to an external storage device or include an internal storage device in which software can be stored and accessed by the CPU.

Referring to FIGS. 5 and 6, the battery 12 can include an electronic component 76 that is in electrical communication with each of the mating connector 24 and the sensors 74. The electronic component 76 can be a processor-based controller, and/or a memory storage device, and/or a communication interface. The electronic component 76 can be configured to receive data from the sensors 74 and transmit the data to the controller 64 via the connectors 22, 24.

When the electronic component 76 is configured as a controller, the electronic component 76 can be configured with hardware alone, or with a combination of hardware and software that permit the electronic component 76 to perform the tasks described herein. The electronic component 76 can include a central processing unit (“CPU”), a RAM, a ROM and/or an interface that connects the electronic component 76 to any or all of the mating connector 24 and the sensors 74.

The battery charging system 10 can be connected to an external power supply 200 in any appropriate manner such as, but not limited to, a plug and wire assembly that can be selectively plugged into and removable from each of the battery charging system 10 and a wall outlet, a plug and wire assembly that is non-removably connected to the battery charging system 10 and selectively plugged into and removable from the wall outlet, or permanent electrical connection. The battery charging system 10 can include an inverter when the external power supply is an alternating current power supply.

The battery charging system 10 can include a respective power supply circuit for each of the heater 16, the cooling fan 62 and charging the battery 12. Each power supply circuit can modulate an output voltage. The power supply circuits can be part of the controller 64 or separate and distinct from the controller 64. The controller 64 can be connected to the external power supply 200. The controller 64 can include or be electrically connected to a respective power supply circuit for each of the heater 16, the battery operation and the cooling fan 62. Each electrical circuit can include one or more components such as, but not limited to, a voltage converter or a power MOSFET that can convert power received from the external power supply 200 to a respective driving power for each heater 16 and the cooling fan 62 and a charging power for the battery 12. The power MOSFET can be manipulated by the controller 64 between an OFF state and an ON state. When any of the powered switches is in the ON state, the respective switch can connect electrical power to respective one(s) of the heater 16, the cooling fan 62 and the battery 12. Each of the power supply circuits can be configured to derive a respective one of a driving power and a charging power from the power received from the external power supply 200.

The controller 64 can be configured to set a respective driving power value for each of the fans 62, 90 and the heating element 92 so that the respective power circuit outputs electrical power derived from the external power supply 200 at the corresponding driving power value. In some embodiments, each of the driving power values can be a respective predetermined fixed value. In other embodiments, the controller 64 can be configured to vary, as a function of the temperature T_{batt} of the battery 12, any one or both of the driving power values.

The controller 64 can be configured to set a respective charging power value for battery 12 so that the respective power circuit outputs electrical power derived from the external power supply 200 at the corresponding charging power value. In some embodiments, the controller 64 can be configured to vary the charging power as a function of the state of charge (“SoC”) of the battery 12. In alternate embodiments, the controller 64 can be configured to set a relatively high voltage power value and subsequently charge the battery 12 with a relatively low current power. The controller 64 can be configured to charge the battery 12 based on the relative high voltage power when the SoC is less than a changeover threshold. The changeover threshold can be a predetermined SoC value that is less than 100% and at which high voltage charging can adversely impact the performance of the battery 12. The controller 64 can be configured to charge the battery 12 based on the relatively low current power when the SoC of the battery 12 is greater than the changeover threshold and less than 100%.

The controller 64 be configured to automatically start and stop the heating mode, the charging mode and the cooling mode of the battery charging system 10. The fans 62, 90 and the heating element 92 can be in an ON state when the controller 64 supplies or causes the supply of the driving power and in an OFF state when the controller 64 disconnects or causes disconnection of the driving power. The cooling mode can be in an ON state when the cooling fan 62 is in the ON state and each of the heating fan 90 and the heating element 92 are in the OFF state. The heating mode can be in an ON state when the cooling fan 62 is in the OFF state and each of the heating fan 90 and the heating element 92 are in the ON state. Each of the fans 62, 90 and the heating element 92 can be described as being connected to the external power supply 200 when in the ON state and disconnected from the external power supply 200 when in the OFF state.

The charging mode can be in an ON state when the controller 64 supplies or causes the supply of the charging power to the battery 12 and in an OFF state when the controller disconnects or causes disconnection of the charging power. The cooling mode can be in the ON state or the OFF state when the charging mode is in the ON state. The heating mode can be in the OFF state when the charging mode is in the ON state, and the heating mode can be in the ON state when the charging mode is in the OFF state. The battery 12 can be described as being connected to the external power supply 200 when the charging mode is in the ON state and disconnected from the external power supply 200 when the charging mode is in the OFF state.

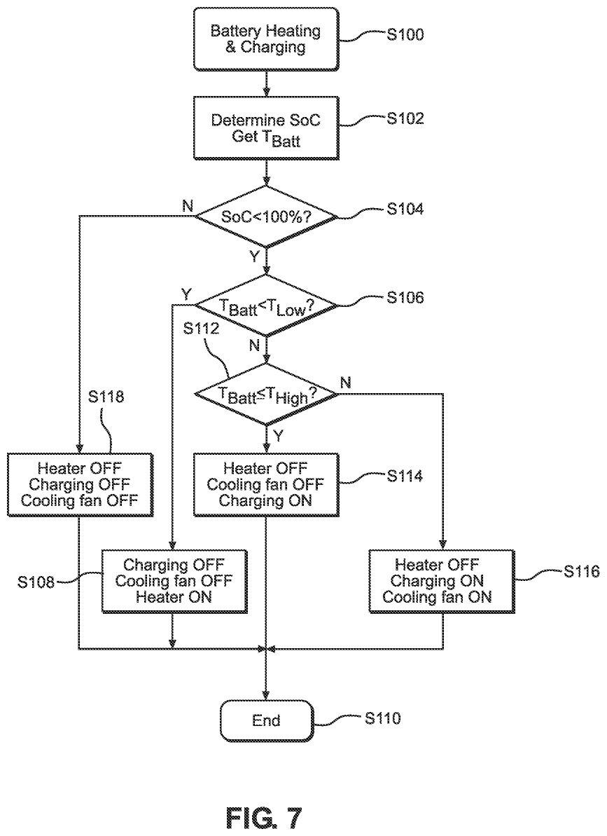

FIG. 7 illustrates a flowchart that represents a battery heating and charging algorithm that can be implemented by the controller 64 in order to start and stop each of the modes of the battery charging system 10.

The controller 64 can be configured to enter the battery heating and charging algorithm at step S100. The controller 64 can be configured to detect the presence or absence of the connection between the connectors 22, 24, and initiate step S100 when the controller 64 determines that the connection between the connectors 22, 24 is present. From step S100, the controller 64 can proceed to step S102.

At step S102, the controller 64 can be configured to determine the SoC of the battery 12 and obtain the battery temperature T_{batt}. The controller 64 can be configured to determine the SoC by any appropriate method that is currently known such as, but not limited to, using the specific gravity of the electrolyte, using the battery voltage and a predetermined discharge curve, or using current integration, or using any appropriate method developed in the future. The controller 64 can be configured to obtain the battery temperature T_{batt} based on the temperature data (or signal) output by the sensors 74.

At step S102, the controller 64 can be configured to transmit a request to the electronic component 76 to transmit the temperature data (or signal) received from the sensors 74. In alternate embodiments, the electronic component 76 can be configured to transmit the temperature data (or signal) to the controller 64 at predetermined intervals. After the controller 64 obtains the temperature T_{batt} and determines the SoC of the battery 12, the controller 64 can proceed to step S104.

At step S104, the controller 64 can be configured to determine whether the SoC corresponds to a 100% charged state of the battery 12. The battery 12 can be considered to be fully charged when the SoC is equal to 100% and in a chargeable state when the SoC is less than 100%. If the controller 64 determines that SoC is less than 100%, the controller 64 can proceed to step S106. If the controller 64 determines that the SoC is not less than 100%, the controller 64 can proceed to step S118.

If the controller 64 proceeds from step S104 to step S106, the controller 64 can be configured to determine whether or not the battery temperature T_{Batt} is acceptable for charging the battery 12. At step S106, the controller 64 can be configured to compare the battery temperature T_{Batt} to the predetermined low temperature T_{Low}. If the battery temperature T_{Batt} is less than the predetermined low temperature T_{Low}, then the battery 12 can be near or below the predetermined minimum temperature and the battery charging system 10 and the heater 16 can be used to heat the battery 12 before the battery charging system 10 charges the battery 12. If the battery temperature T_{Batt} is less than the predetermined low temperature T_{Low}, then the controller 64 can proceed to step S108. If the battery temperature T_{Batt} is greater than or equal to the predetermined low temperature T_{Low}, then the controller 64 can proceed to step S112.

If the controller 64 proceeds from step S106 to step S108, then the battery 12 is too cold for charging. At step S108, the controller 64 can be configured to initiate the heating mode of the battery charging system 10, or maintain the heating mode in the ON state if the heating mode is presently in the ON state. The controller 64 can be configured to disconnect or maintain disconnection of the cooling fan 16 from its respective driving power (i.e., cooling fan 62 is in the OFF state), and disconnect or maintain disconnection of the battery 12 from its charging power (i.e., charging mode is in OFF state). The controller 64 can be configured to set and output (or cause the output of) the driving power for the heating fan 90 and set and output (or cause the output of) the driving power for the heating element 92. The controller 64 can be configured to proceed to step S110 after completing step S116.

At step S110, the controller 64 can be configured to exit the battery heating and charging algorithm. The controller 64 can be configured to execute the battery heating and charging algorithm at predetermined intervals of operation of the battery charging systems 10.

If the controller 64 proceeds from step S106 to step S112, the battery temperature T_{Batt} is acceptable for charging the battery 12. The battery temperature T_{Batt} can increase during charging. If the battery temperature T_{Batt} is greater than the predetermined high temperature T_{High}, then the battery 12 is approaching the predetermined maximum temperature and the battery charging system 10 can be operated in the cooling mode (i.e., the cooling mode is in the ON state). If the battery temperature T_{Batt} is less than or equal to the predetermined high temperature T_{High}, then the battery 12 is in an acceptable state for charging without the cooling mode in the ON state.

At step S112, the controller 64 can be configured to determine whether the cooling mode should be placed in the ON state. The controller 64 can be configured to compare the battery temperature T_{Batt} to the predetermined high temperature T_{High}. If the controller 64 determines that the battery temperature T_{Batt} is less than or equal to the predetermined high temperature T_{High}, then the controller 64 can be configured to proceed to step S114. If the controller 64 determines that the battery temperature T_{Batt} is not less than or equal to the predetermined high temperature T_{High}, then the controller 64 can be configured to proceed to step S116.

At step S114, the controller 64 can start or maintain the charging mode in the ON state, and each of the heating mode and the cooling mode in the OFF state. The controller 64 can be configured to connect or maintain connection of the battery 12 to the charging power, disconnect or maintain disconnection of the heater 16 from its respective driving power (i.e., heater 16 is in the OFF state), and disconnect or maintain disconnection of the cooling fan 62 to its respective driving power (i.e., cooling fan 62 is in the OFF state). The controller 64 can be configured to set and output (or cause the output) of the charging power for the battery 12. The controller 64 can be configured to proceed to step S110 after completing step S114 and exit the battery heating and charging algorithm.

If the controller 64 proceeds from step S112 to step S116, then controller 64 can be configured to start the cooling mode and the charging mode of the battery charging system 10, or maintain any of the cooling mode and the charging mode in the ON state if any of the charging mode and the cooling mode is presently in the ON state. The controller 64 can be configured to disconnect or maintain disconnection of the heater 16 from its respective driving power (i.e., heater 16 is in the OFF state), connect or maintain connection of the cooling fan 62 to its respective driving power (i.e., cooling fan 62 is in the ON state), and connect or maintain connection of the battery 12 to its charging power (i.e., charging mode is in the ON state). The controller 64 can be configured to set and output (or cause the output) of the driving power for the cooling fan 62 and set and output (or cause the output) of the charging power for the battery 12. The controller 64 can be configured to proceed to step S110 after completing step S116 and exit the battery heating and charging algorithm.

If the controller 64 proceeds from step S104 to step S118, then the battery 12 is fully charged (i.e., the SoC is equal to 100%) and the controller 64 can stop operating the battery charging system 10. At step S118, the controller 64 can be configured to turn off the heater 16, turn off the charging mode, and turn off the cooling fan 62. That is, the controller can be configured to place each of heater 16, the charging mode, and the cooling fan 62 in the OFF state. In the event that any of the heater 16, the charging mode and the cooling fan are in the OFF state when the controller 64 enters step S118, the controller 64 can be configured to maintain the OFF state of any of the heater 16, the charging mode and the cooling fan 62 that are presently in the OFF state. That is, controller 64 can be configured disconnect or maintain disconnection of each of the heater 16, the charging mode and the cooling fan 62 from the external power supply 200. After completing step S118, the controller 64 can proceed to step S110 and exit the battery heating and charging algorithm.

Thus, the battery charging system 10 can charge a battery 12 that is initially too cold for charging. The battery charging system 10 can automatically detect the temperature of the battery 12 and determine the ON state or the OFF state for each the heating mode, the charging mode and the cooling mode. The automatic selection of the heating mode, the charging mode and the cooling mode can be perceived as convenient and efficient by the owner or user of the battery charging system 10.

In order enhance the positive perception by the owner or user, the battery charging system 10 can provide the owner or user with information regarding the operation of battery charging system 10. Returning to FIG. 4, the battery charging system 10 can include a display 96 that is in electrical communication with the controller 64. The display 96 can be any appropriate display such as, but not limited to, a touch screen or a liquid crystal display (“LCD”). The display can be configured to display any one or any combination of text, image(s), or icon(s), in color or monochrome. The text, image(s), icon(s) can convey information indicating any one of or any combination of the SoC, the battery temperature T_{Batt}, ambient temperature, the heat output by the heater 16, the remaining time for heating the battery 12, the remaining time for charging the battery 12 and/or any other information that is pertinent to the charging of the battery 12, usage of the battery 12, and usage of the battery charging system 10.

The controller 64 can be configured to calculate the remaining time for heating battery 12 based on the temperature data from the sensors 74 and the driving power set for heating fan 90 and the heating element 92. The controller 64 can be configured to output a signal to the display 96, or a separate driver for the display 96, that causes the display 96 to display the remaining time. The controller 64 can be configured to update the displayed information in predetermined intervals. The controller 64 can be configured to cause the display 96 to indicate when the battery 12 is fully charged. Thus, the display 96 can enhance the owner's or user's positive perception of the battery charging system 10.

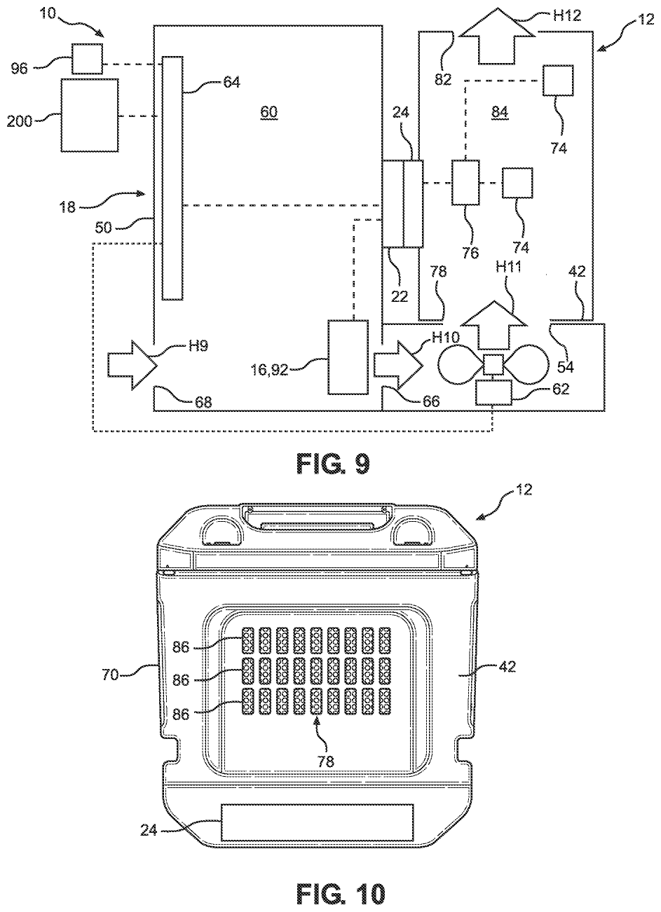

FIG. 9 schematically illustrates an alternate embodiment of a battery charging system 100 that can include the housing 18, the battery dock 20, the cooling fan 62, the heating element 92 and the display 96 described above with respect to FIGS. 1-8. The heating fan 90 can be omitted from the heater 16. Thus, instead of the forced convection of the battery charging system 10, the battery charging system 100 can use natural convection to transfer heat from the heating element 92 to the battery cells 72.

The air inside the interior space 60 of the housing 18 that has been heated by the heating element 92 is warmer and less dense than the air that is outside of the housing 18, in the battery dock 20, and in the battery compartment 84. This density difference can create a convective current that follows the airflow path indicated by the arrows H9-H12. When the battery charging system 100 and the heating element 92 operate in heating mode, the denser ambient air that is outside the housing 18 can enter the housing 18 through the housing opening 68 and flow into the interior space 60 of the housing 18 as indicated by the ninth arrow H9. The air heated by heating element 92 can be drawn through the intermediate opening 66 and enter the internal space 52 of the end wall 26 of the battery dock 20 as indicated by the tenth arrow H10. The heated air in the internal space 52 can exit the internal space 52 through the dock opening 54 and enter the battery 12 via the first ventilation opening 78 as indicated by the eleventh arrow H11. The heating air can flow through the battery compartment 84 and across or along each of the battery cells 72. The air flowing across or along the battery cells 12 can exit the battery compartment 84 through the second ventilation opening 82 and flow into the ambient environment as indicated by the twelfth arrow H12. Thus, the heater 16 can heat the battery cells 72 when the battery cells 72 are at a temperature that is less than the predetermined low temperature T_{LOW}.

The controller 64 of the battery charging system 100 can be configured to execute the battery heating and charging algorithm as described above with respect to FIG. 7, with the exception that the controller 64 does not set or output (or cause the output of) a driving power for the omitted heating fan 90.

Without the heating fan 90, the battery charging system 100 can weigh less, be less expensive, and be as convenient as compared to the battery charging system 10.

While certain embodiments of the invention are described above, it should be understood that the invention can be embodied and configured in many different ways without departing from the spirit and scope of the invention.

Instead of deriving the driving power for the heating element 92 from the external power supply, alternate embodiments of the battery charging system 10 or 100 can be configured to supply the driving power from the battery 12. The battery temperature T_{Batt} of the battery 12 can increase when the battery 12 discharges electric power to a load. Due to the relative high resistance of the heating element 92, the heat generated in the battery 12 can be of a rate that is advantageous for heating the battery 12 when the battery temperature T_{Batt} is less than the predetermined low temperature T_{Low}. Further, the convective heating created by the heating element 92 alone (FIG. 9) or in combination with the heating fan 90 can reduce the elapsed time for the battery temperature T_{Batt} to exceed the predetermined low temperature T_{Low}.

In the alternate embodiments in which the battery 12 supplies power to the heating element 92, the controller 64 or the electronic component 76 can be configured to selectively connect and disconnect the battery 12 to/from the heating element 92 based on the battery temperature T_{Batt}, the SoC of the battery 12, and/or any other appropriate parameter(s).

In the embodiments of FIGS. 1-9, the controller 64 can be configured to execute all of the steps of the battery heating and charging algorithm of FIG. 7. However, alternate embodiments can split the steps amongst the controller 64 and the electronic component 76 where the electronic component 76 is a second controller. In exemplary embodiments, the electronic component 76 can be configured to perform steps S100, S102, S106 and S112 and transmit appropriate data (or signal(s)) to the controller 64, and the controller 64 can be configured to perform steps S100, S108, S114, S116 and S118 and request the appropriate data (or signal(s)) from the electronic component 76. However, either the controller 64 or the electronic component 76 as a second controller can execute any one of the steps or any subcombination of the steps of FIG. 7 and the other of the controller 64 and the electronic component 76 as a second controller can execute any of the remainder of the steps of FIG. 7. Alternatively, a single controller can be used in place of the disclosed controller 64 and electronic component 76, or multiple controllers and electronic parts can be used.

In alternate embodiments, the controller 64 and/or the electronic component 76 can execute the steps S104-S108 and S112-S118 in any order that is different from that shown in and described with reference to FIG. 7, so long as the controller 64 and/or the electronic component 76 can properly cause the heating, charging and cooling of the battery 12.

In alternate embodiments, the electronic component 76 can be omitted and the controller 64 can be configured to receive the data (or signals) from the sensors 74 via the connectors 22, 24.

Instead of charging the battery 12 via electricity flowing from the connector 22 to the mating connector 24, the battery 12 and the battery charging system 10 can be configured for wireless charging (and/or wireless communication between components). Instead of the connectors 22, 24, the battery 12 and the battery dock can have appropriate wireless charging structures.

In alternate embodiments, the electronic component 76 can be omitted and all of the tasks described with reference to FIG. 7 can be performed by the controller 64.

In alternate embodiments, the controller 64 can be configured to initially set the driving power for the cooling fan 62 at a maximum value and then decrease the driving power as a difference between the battery temperature T_{Batt} and the predetermined high temperature T_{High} decreases.

In alternate embodiments, the controller 64 can be configured to initially set the driving power for the heating fan 62 and the driving power for the heating element 92 at respective maximum values and then decrease the driving power for each as a difference between the battery temperature T_{Batt} and the predetermined low temperature T_{Low} decreases.

In alternate embodiments, one or both of the side walls 30, 32 can be omitted from the battery dock 20. In alternate embodiments all of the walls 26, 30,32 can be omitted from the battery dock 20, and the cooling fan 62 and the dock opening 54 can be relocated in the support wall 28.

In alternate embodiments, the battery charging system 10 can include a power button that is actuated by the user, and the controller 64 can be configured to detect the presence or absence of the battery 12 when the controller receives a signal from the power button that is indicative of the user's request for charging the battery 12. The controller 64 can be configured to enter the battery heating and charging algorithm at step S100 when the controller 64 receives an appropriate signal from the power button.

In alternate embodiments, the battery dock 20 can include a hollow compartment into which the battery 12 can be inserted. At least a portion of the compartment can be exposed to the ambient environment so that air can be exhausted from the battery 12 into the ambient environment during the heating mode and air can be drawn from the ambient environment and into the battery 12 during the cooling mode.

Although FIG. 4 shows the controller 64 in the interior space 60 of the housing 18, alternate embodiments can include the controller 64 located anywhere inside or outside of the housing 18 or inside the battery dock 20. In alternate embodiments, the controller 64 can be enclosed in a compartment that is separated from the housing 18 and the battery dock 20.

Although FIGS. 1-9 show the electronic component 76 in the battery compartment 84, the electronic component 76 can be located anywhere in or on the battery 12 and can be located separate from the battery compartment 84.

The housing opening 68 can be in any of the walls 34, 46, 48, 50 instead of, or in addition to, the first side wall 46.

In alternate embodiments, the surfaces 36, 42 can abut each other.

What is claimed is:

1. A battery charging system, comprising:
a heating element located in an airflow path;
a heating fan located in the airflow path upstream of the heating element when the heating fan is operated during a heating mode;
a cooling fan located in the airflow path downstream of the heating element when the heating fan is operated during the heating mode; and
a controller configured to operate the heating mode when a battery is connected to the battery charging system and a sensed temperature of the battery is less than a predetermined low threshold, the controller is configured to operate the heating mode by
disconnecting or maintaining disconnection of a charging power from the battery,
supplying or maintaining a fan power to the heating fan to force air to flow along the airflow path,
supplying or maintaining a heat power to the heating element to emit heat into the airflow path, and
disconnecting or maintaining disconnection of a cooling power from the cooling fan, wherein
in the heating mode, air flowing along the airflow path flows through the heating fan and enters the heating element, and the air that enters the heating element exits the heating element and passes along the cooling fan.

2. The battery charging system according to claim 1, further comprising:
a battery dock configured to receive the battery when the battery is connected to the battery charging system, the battery dock is located such that the airflow path passes along the battery dock downstream of the heating element in the heating mode.

3. The battery charging system according to claim 2, wherein the controller is configured to operate a charging mode when the battery is connected to the battery charging system, and when the sensed temperature is greater than or equal to the predetermined low threshold and less than or equal to a predetermined high threshold, the predetermined high threshold is greater than the predetermined low threshold, the controller is configured to operate the charging mode by
connecting or maintaining connection of the charging power to the battery,
disconnecting or maintaining disconnection of the fan power from the heating fan,
disconnecting or maintaining disconnection of the heat power from the heating element, and
disconnecting or maintaining disconnection of the cooling power from the cooling fan.

4. The battery charging system according to claim 3, wherein
the controller is configured to operate a cooling mode when battery is connected to the battery charging system and the sensed temperature is greater than the predetermined high threshold, the controller is configured to operate the cooling mode by
connecting or maintaining connection of the charging power to the battery,
disconnecting or maintaining disconnection of the fan power from the heating fan,
disconnecting or maintaining disconnection of heat power from the heating element, and
supplying or maintaining the cooling power to the cooling fan to force air to flow along the airflow path, and
in the cooling mode, air flowing along the airflow path flows through the battery and subsequently flows past the heating element and the heating fan when the battery is connected to the battery charging system.

5. The battery charging system according to claim 4, further comprising:
a housing that includes an interior space and a first opening, the first opening and at least a portion of the interior space are in the airflow path, the first opening is in fluid communication with an ambient environment outside of the housing, wherein
the battery dock includes an internal space and a second opening in the airflow path, the internal space is in fluid communication with the interior space, and the second opening is in fluid communication with the internal space, and
the heating element, the heating fan, and the cooling fan are located along the airflow path between the first opening and the second opening,
the heating element and the heating fan are located in the interior space of the housing,
the cooling fan is located in the internal space of the battery dock,
in the heating mode, the heating fan draws air from outside the housing into the interior space of the housing via the first opening, the air drawn into the interior space by the heating fan passes through the heating element and exits the internal space of the battery dock via the second opening, and
in the cooling mode, the cooling fan draws air from the battery when the battery is received by the battery dock, the air drawn by the cooling fan enters the second opening, passes through the internal space and the interior space, and exits the housing via the first opening.

6. The battery charging system according to claim 1, further comprising:
a battery dock configured to receive a battery;
a first compartment in the battery dock, the cooling fan is contained in the first compartment;
a second compartment adjacent to the first compartment, each of the controller and the heater are contained in the second compartment; and
a first opening located in the airflow path and in fluid communication with each of the battery and the first compartment,
a second opening located in the airflow path and in fluid communication with each of the first compartment and the second compartment, and
a third opening located in the airflow path and in fluid communication with each of the second compartment and an ambient environment outside of the second compartment.

7. The battery charging system according to claim 1, wherein the controller is configured to,
be connected to a power supply that is external to both the battery charging system and the battery that is to be charged by the battery charging system;
selectively convert power received from the power supply to a charging power when the controller sets one of the charging mode and the cooling mode, and
transmit the charging power to the electrical connector.

8. The battery charging system according to claim 7, wherein the controller is configured to electrically connect the heating element to the power supply when the controller sets the heating mode.

9. The battery charging system according to claim 8, wherein, when the controller sets the heating mode, the controller is configured to,
calculate a heater power output to be emitted by the heating element based on the sensed temperature, and
cause the heater element to emit heat at the heater power output.

10. The battery charging system according to claim 9, further comprising:
a display screen that is electrically connected to the controller, wherein
the controller is configured to,
calculate an estimated wait time that corresponds to a difference between a start time of setting the heating mode and an estimated time of setting the charging mode, and
cause the display screen to display the estimated wait time and the heater power output.

11. The battery charging system according to claim 1, wherein the controller is configured to electrically connect the battery to the heater when the controller sets the heating mode.

12. A battery power system for an apparatus that includes an electric motor and a tool driven by the electric motor, the battery charging system comprising:
a battery configured to be removably mounted on the apparatus and electrically connected to the apparatus to supply electrical power to the motor when the battery is mounted on the apparatus; and
a battery charging system connected to a power supply and including:
a battery dock configured to removably receive the battery and electrically connect the battery to the battery charging system when the battery is received in the battery dock;
a heater located in an airflow path that passes along the battery dock and is configured to heat the battery when the battery is received in the battery dock;
a cooling fan located in an airflow path between the battery dock and the heater; and
a controller configured to operate a heating mode when the battery is received in the battery dock and a sensed temperature is less than a predetermined low threshold, the controller configured to operate the heating mode by
disconnecting or maintaining disconnection of a charging power from the battery,
connecting or maintaining connection of a heat power to the heater, and
disconnecting or maintaining disconnection of a cooling power from the cooling fan.

13. The battery charging system according to claim 12, wherein the heater includes:
a heating fan that is located in the airflow path at a position that is spaced away from the cooling fan; and
a heating element that is located in the airflow path at a position that is between the heating fan and the cooling fan.

14. The battery charging system according to claim 12, wherein the controller is configured to operate a charging mode when the battery is received by the battery dock and when the sensed temperature is greater than or equal to the predetermined low threshold and less than or equal to a predetermined high threshold, the predetermined high threshold is greater than the predetermined low threshold, the controller is configured to operate the charging mode by
connecting or maintaining connection of the charging power to the battery,
disconnecting or maintaining disconnection of the heat power from the heater, and
disconnecting or maintaining disconnection of the cooling power from the cooling fan.

15. The battery charging system according to claim 12, wherein
the quick charger includes a housing containing the heater, and the housing includes a first opening in fluid communication with an ambient environment outside of the housing,
the battery dock is adjacent to the housing and includes an external space and a second opening that is in fluid communication with the external space,
the airflow path extends from the first opening, through the housing, through the second opening, and into the external space, and
the battery is located in the external space when the battery is received by the battery dock, and the battery includes a ventilation opening that is in fluid communication with one of the external space and the second opening,
the cooling fan is mounted in the battery dock at a location in the airflow path that is between the second opening and the heater, and
the heater is mounted in the housing at a location in the airflow path that is between the cooling fan and the first opening.

16. The battery charging system according to claim 12, wherein
the battery includes a plurality of battery cells and a plurality of thermistors, and
a respective one of the thermistors abuts a respective one of the battery cells and is configured to output a respective temperature data signal to the controller,
the temperature data includes the temperature signal output by each of the thermistors, and
the controller is configured to set the sensed temperature based on the temperature data.

17. The battery charging system according to claim 16, wherein
the plurality of battery cells are arranged in one of a row and a column andinclude,
an end battery cell located at an end of the one of the row and the column, and
a middle battery cell spaced away from the end of the one of the row and the column, and
the plurality of thermistors includes a first thermistor abutting the end battery cell and a second thermistor abutting the middle battery cell.

18. A method of using a quick charger to charge a battery mounted in the quick charger, the quick charger having a heater, a cooling fan, and an opening adjacent to the battery when the battery is mounted in the quick charger, the method comprising:
locating the heater, the cooling fan and the opening in an airflow path that extends from the heater and through the opening such that the cooling fan is located between the heater and the opening; and
when a sensed temperature of the battery is less than a predetermined low threshold,
disconnecting or maintaining disconnection of the battery from a power supply;
connecting or maintaining connection of the heater to one of the power supply and the battery, and
disconnecting or maintaining disconnection of the cooling fan from the power supply.

19. The method according to claim 18, further comprising:
when the sensed temperature is greater than or equal to the predetermined low threshold and less than or equal to a predetermined high threshold that is greater than the predetermined low threshold,
connecting or maintaining connection of the battery to the power supply,
disconnecting or maintaining disconnection of the cooling fan from the power supply, and
disconnecting or maintaining disconnection of the heater from the one of the power supply and the battery; and
when the sensed temperature is greater than the predetermined high threshold,
connecting or maintaining connection of the battery to the power supply,
connecting or maintaining connection of the cooling fan to the power supply, and
disconnecting or maintaining disconnection of the heater from the one of the power supply and the battery.

20. The method according to claim 19, further comprising:
setting the sensed temperature based on a plurality of temperature signals;
varying a heater power output by the heater based on the sensed temperature;
calculating an estimated wait time until a start of charging of the battery; and
displaying the wait time and the heater power on a display.
